(19) United States
(12) Patent Application Publication
(10) Pub. No.: US 2026/0360199 A1
(43) Pub. Date: Nov. 12, 2026

(54) DATA COLLECTION METHOD, CENTER, STORAGE MEDIUM STORING DATA COLLECTION PROGRAM, DATA COLLECTION SYSTEM

(71) Applicant: DENSO CORPORATION, Kariya-shi (JP)

(72) Inventors: Yutaro OZAWA, Kariya-shi (JP); Seisuke KASAOKI, Kariya-shi (JP)

(21) Appl. No.: 19/717,994

(22) Filed: Jun. 24, 2026

Related U.S. Application Data
(63) Continuation of application No. PCT/JP2024/044823, filed on Dec. 18, 2024.

(30) Foreign Application Priority Data
Dec. 28, 2023 (JP) 2023-223211

(51) Int. Cl. G07C 5/08; G06F 21/62; G07C 5/00

(52) U.S. Cl. CPC G07C 5/085; G06F 21/629; G07C 5/008

(57) ABSTRACT

A data collection method is executed in a center configured to receive vehicle data from a plurality of in-vehicle devices mounted in each of a plurality of vehicles, the vehicle data including at least information relating to a vehicle. The data collection method includes: storing the vehicle data received from the plurality of in-vehicle devices; identifying a scene in which the machine learning model does not satisfy a preset evaluation criterion; generating collection condition data indicating a collection condition including a collection data item and a collection start condition; storing the generated collection condition data in association with scene identification information; delivering the collection condition data to the plurality of in-vehicle devices; and storing the vehicle data uploaded from the plurality of in-vehicle devices based on the collection condition data.

### CROSS REFERENCE TO RELATED APPLICATIONS

The present application is a continuation application of International Patent Application No. PCT/JP2024/044823 filed on Dec. 18, 2024 which designated the U.S. and claims the benefit of priority from Japanese Patent Application No. 2023-223211 filed on Dec. 28, 2023. The entire disclosures of all of the above applications are incorporated herein by reference.

### TECHNICAL FIELD

The present disclosure relates to a technique for collecting data from a plurality of vehicles.

### BACKGROUND

A related art describes a system that collects vehicle data from a plurality of in-vehicle devices mounted in respective ones of a plurality of vehicles.

### SUMMARY

According to an aspect of the present disclosure, a data collection method is executed in a center configured to receive vehicle data from a plurality of in-vehicle devices mounted in each of a plurality of vehicles. The vehicle data includes at least information relating to a vehicle on which the in-vehicle device is mounted. The data collection method may include: storing the vehicle data received from the plurality of in-vehicle devices; identifying, based on a result of model evaluation obtained by performing machine learning including annotation, model training, and model evaluation on a machine learning model using the stored vehicle data, a scene in which the machine learning model does not satisfy a preset evaluation criterion; generating, for the identified scene, collection condition data indicating a collection condition including a collection data item indicating a type of the vehicle data to be collected and a collection start condition for starting data collection; storing the generated collection condition data in association with scene identification information for identifying the scene; delivering the collection condition data to the plurality of in-vehicle devices; and storing, in association with the scene identification information, the vehicle data uploaded from the plurality of in-vehicle devices based on the collection condition data.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating a configuration of a data collection system according to a first embodiment;

FIG. 2 is a block diagram illustrating a configuration of a data collection device;

FIG. 3 is a block diagram illustrating a configuration of a center;

FIG. 4 is a functional block diagram illustrating a functional configuration of the center;

FIG. 5 is a diagram for explaining management of collection condition data and collected data;

FIG. 6 is a diagram for explaining traceability of an AI model;

FIG. 7 is a flowchart showing collection data management processing;

FIG. 8 is a flowchart showing the first half of model learning processing;

FIG. 9 is a flowchart showing the second half of the model learning processing;

FIG. 10 is a flowchart showing collection condition generation processing;

FIG. 11 is a flowchart showing delivery processing;

FIG. 12 is a flowchart showing data collection processing; and

FIG. 13 is a block diagram illustrating a configuration of a data collection system according to a second embodiment.

### DETAILED DESCRIPTION

As a result of detailed study by the inventors, it was found that, because the data handled by vehicles is highly diverse, there is a need to efficiently collect data from a plurality of in-vehicle devices.

The present disclosure efficiently collects data from a plurality of in-vehicle devices.

According to one aspect of the present disclosure, a data collection method is executed in a center configured to receive vehicle data from a plurality of in-vehicle devices mounted in each of a plurality of vehicles. The vehicle data includes at least information relating to a vehicle on which the in-vehicle device is mounted. The data collection method includes: storing the vehicle data received from the plurality of in-vehicle devices; identifying, based on a result of model evaluation obtained by performing machine learning including annotation, model training, and model evaluation on a machine learning model using the stored vehicle data, a scene in which the machine learning model does not satisfy a preset evaluation criterion; generating, for the identified scene, collection condition data indicating a collection condition including a collection data item indicating a type of the vehicle data to be collected and a collection start condition for starting data collection; storing the generated collection condition data in association with scene identification information for identifying the scene; delivering the collection condition data to the plurality of in-vehicle devices; and storing, in association with the scene identification information, the vehicle data uploaded from the plurality of in-vehicle devices based on the collection condition data.

The data collection method of the present disclosure configured as described above can collect vehicle data by narrowing down the data according to scenes, and thus can efficiently collect data from a plurality of in-vehicle devices. Further, the data collection method of the present disclosure identifies a scene that does not satisfy the evaluation criterion and generates collection condition data, and thus can efficiently generate collection condition data.

According to one aspect of the present disclosure, a center is configured to receive vehicle data from a plurality of in-vehicle devices mounted in each of a plurality of vehicles. The vehicle data includes at least information relating to a vehicle on which the in-vehicle device is mounted. The center includes: a data storage unit configured to store the vehicle data received from the plurality of in-vehicle devices; a collection condition generation unit configured to identify, based on a result of model evaluation obtained by performing machine learning including annotation, model training, and model evaluation on a machine learning model using the stored vehicle data, a scene in which the machine learning model does not satisfy a preset evaluation criterion, generate, for the identified scene, collection condition data indicating a collection condition including a collection data item indicating a type of the vehicle data to be collected and a collection start condition for starting data collection, and store the generated collection condition data in association with scene identification information for identifying the scene; and a delivery unit configured to deliver the collection condition data to the plurality of in-vehicle devices. The data storage unit is configured to store, in association with the scene identification information, the vehicle data uploaded from the plurality of in-vehicle devices based on the collection condition data.

The center of the present disclosure is a device that executes the data collection method of the present disclosure, and can obtain the same effects as those of the data collection method of the present disclosure.

According to one aspect of the present disclosure, a data collection program causes a computer of a center configured to receive vehicle data from a plurality of in-vehicle devices mounted in each of a plurality of vehicles, the vehicle data including at least information relating to a vehicle on which the in-vehicle device is mounted, to function as: a data storage unit configured to store the vehicle data received from the plurality of in-vehicle devices; a collection condition generation unit configured to: identify, based on a result of model evaluation obtained by performing machine learning including annotation, model training, and model evaluation on a machine learning model using the stored vehicle data, a scene in which the machine learning model does not satisfy a preset evaluation criterion; generate, for the identified scene, collection condition data indicating a collection condition including a collection data item indicating a type of the vehicle data to be collected and a collection start condition for starting data collection; and store the generated collection condition data in association with scene identification information for identifying the scene; and a delivery unit configured to deliver the collection condition data to the plurality of in-vehicle devices. The data storage unit is configured to store, in association with the scene identification information, the vehicle data uploaded from the plurality of in-vehicle devices based on the collection condition data.

A computer controlled by the data collection program of the present disclosure can constitute a part of the center of the present disclosure and can achieve the same effects as the center of the present disclosure.

According to one aspect of the present disclosure, a data collection system includes: a plurality of in-vehicle devices mounted in respective ones of a plurality of vehicles and configured to transmit vehicle data including at least information relating to the vehicle on which the in-vehicle device is mounted; and a center configured to receive the vehicle data from the plurality of in-vehicle devices. The center includes: a data storage unit configured to store the vehicle data received from the plurality of in-vehicle devices; a collection condition generation unit configured to: identify, based on a result of model evaluation obtained by performing machine learning including annotation, model training, and model evaluation on a machine learning model using the stored vehicle data, a scene in which the machine learning model does not satisfy a preset evaluation criterion; generate, for the identified scene, collection condition data indicating a collection condition including a collection data item indicating a type of the vehicle data to be collected and a collection start condition for starting data collection; and store the generated collection condition data in association with scene identification information for identifying the scene; and a delivery unit configured to deliver the collection condition data to the plurality of in-vehicle devices. The data storage unit is configured to store, in association with the scene identification information, the vehicle data uploaded from the plurality of in-vehicle devices based on the collection condition data. The plurality of in-vehicle devices include: a collection unit configured to, upon receiving the collection condition data from the center, collect the vehicle data corresponding to the collection data item at a timing at which the collection start condition is satisfied, based on the collection condition indicated by the collection condition data; and an upload unit configured to upload the vehicle data collected based on the collection condition to the center in association with the collection condition.

The data collection system of the present disclosure is a system that executes the data collection method of the present disclosure, and can achieve the same effects as the data collection method of the present disclosure.

According to one aspect of the present disclosure, a data collection method is executed in a data collection system including a plurality of in-vehicle devices mounted in respective ones of a plurality of vehicles and configured to transmit vehicle data including at least information relating to the vehicle on which the in-vehicle device is mounted, and a center configured to receive the vehicle data from the plurality of in-vehicle devices. The data collection method includes: by the center, storing the vehicle data received from the plurality of in-vehicle devices; identifying, based on a result of model evaluation obtained by performing machine learning including annotation, model training, and model evaluation on a machine learning model using the stored vehicle data, a scene in which the machine learning model does not satisfy a preset evaluation criterion; generating, for the identified scene, collection condition data indicating a collection condition including a collection data item indicating a type of the vehicle data to be collected and a collection start condition for starting data collection; and storing the generated collection condition data in association with scene identification information for identifying the scene; delivering the collection condition data to the plurality of in-vehicle devices; and storing the vehicle data uploaded from the plurality of in-vehicle devices based on the collection condition data in association with the scene identification information. The data collection method includes: by the plurality of in-vehicle devices, collecting, upon receiving the collection condition data from the center, the vehicle data corresponding to the collection data item at a timing at which the collection start condition is satisfied, based on the collection condition indicated by the collection condition data; and uploading the vehicle data collected based on the collection condition to the center in association with the collection condition.

The data collection method of the present disclosure is a method executed by the data collection system of the present disclosure, and by executing the method, the same effects as those of the data collection system of the present disclosure can be obtained.

### First Embodiment

The first embodiment of the present disclosure will be described below with reference to the drawings.

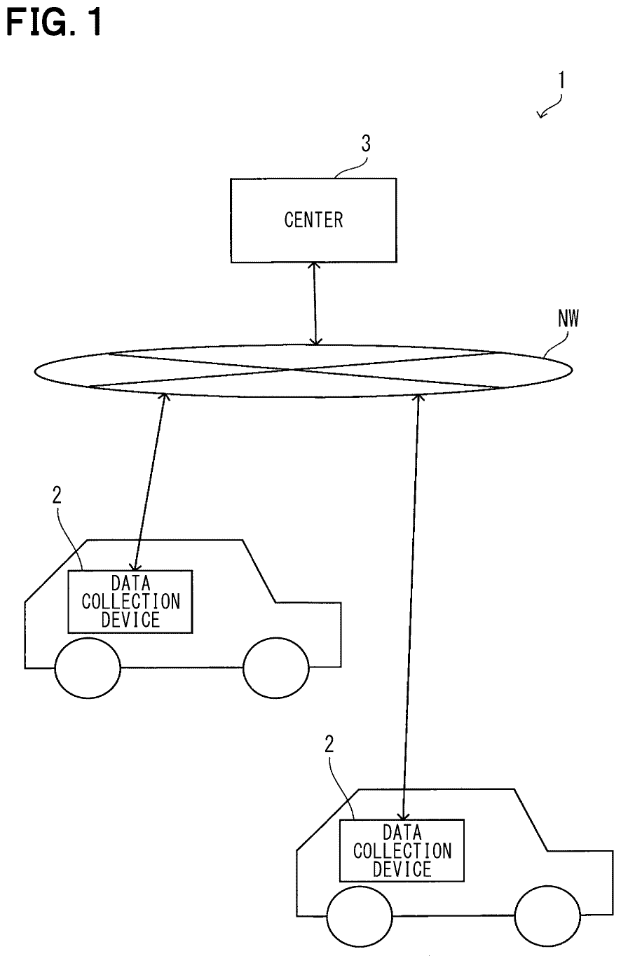

As shown in FIG. 1, a data collection system 1 according to the present embodiment includes a plurality of data collection devices 2 and a center 3.

The data collection device 2 is mounted on a vehicle and has a function of performing data communication with the center 3 via a wide-area wireless communication network NW.

The center 3 is a device that manages the data collection system 1. The center 3 has a function of performing data communication with the plurality of data collection devices 2 via the wide-area wireless communication network NW.

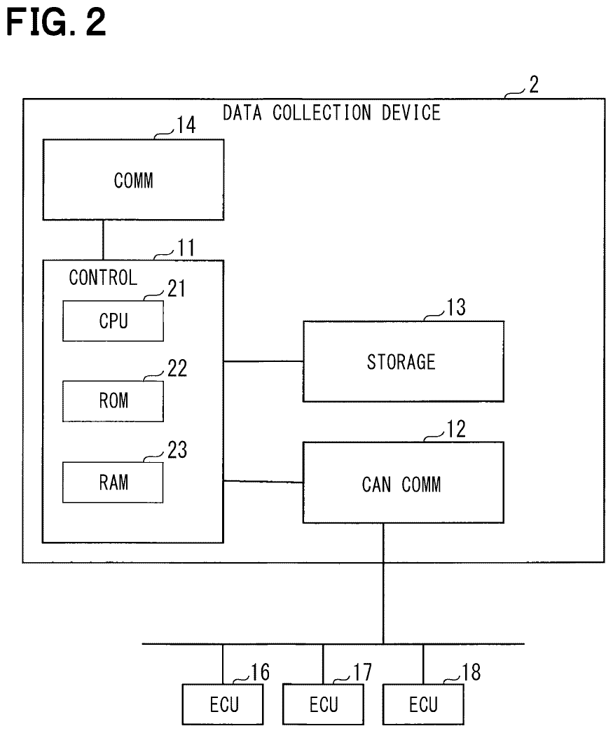

As shown in FIG. 2, the data collection device 2 includes a control unit 11, a CAN communication unit 12, a storage unit 13, and a communication unit 14. CAN is an abbreviation for Controller Area Network.

The control unit 11 is an electronic control device mainly configured around a microcomputer including a CPU 21, a ROM 22, a RAM 23, and the like. Various functions of the microcomputer are realized by the CPU 21 executing a program stored in a non-transitory computer-readable recording medium. In this example, the ROM 22 corresponds to the non-transitory computer-readable recording medium in which the program is stored. Further, by execution of this program, a method corresponding to the program is executed. Note that some or all of the functions executed by the CPU 21 may be implemented in hardware by one or more ICs or the like. The number of microcomputers constituting the control unit 11 may be one or more.

The CAN communication unit 12 is connected so as to enable data communication with a plurality of ECUs via communication lines, and transmits and receives data according to a CAN communication protocol. Specifically, the plurality of ECUs connected to the CAN communication unit 12 are, for example, an engine ECU that performs engine control, a brake ECU that performs brake control, a steering ECU that performs steering control, a suspension ECU that performs suspension control, and an ECU that controls lights on and off. In FIG. 2, only ECUs 16, 17, and 18 are illustrated as ECUs connected to the CAN communication unit 12. ECU is an abbreviation for Electronic Control Unit.

The storage unit 13 is a storage device for storing various kinds of data.

The communication unit 14 performs data communication with the center 3 via the wide-area wireless communication network NW.

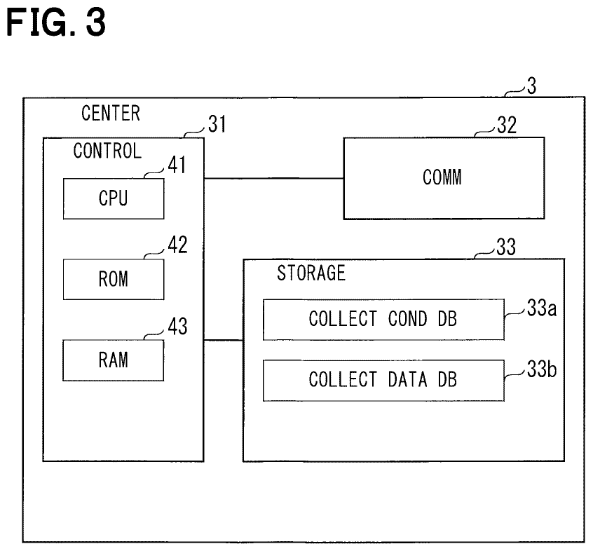

As shown in FIG. 3, the center 3 includes a control unit 31, a communication unit 32, and a storage unit 33.

The control unit 31 is an electronic control device mainly configured around a microcomputer including a CPU 41, a ROM 42, a RAM 43, and the like. Various functions of the microcomputer are realized by the CPU 41 executing a program stored in a non-transitory computer-readable recording medium. In this example, the ROM 42 corresponds to the non-transitory computer-readable recording medium in which the program is stored. Further, by execution of this program, a method corresponding to the program is executed. Note that some or all of the functions executed by the CPU 41 may be implemented in hardware by one or more ICs or the like. The number of microcomputers constituting the control unit 31 may be one or more.

The communication unit 32 performs data communication with the plurality of data collection devices 2 via the wide-area wireless communication network NW.

The storage unit 33 is a storage device for storing various kinds of data. The storage unit 33 is provided with a collection condition database (a collection condition DB) 33a and a collection data database (a collection data DB) 33b.

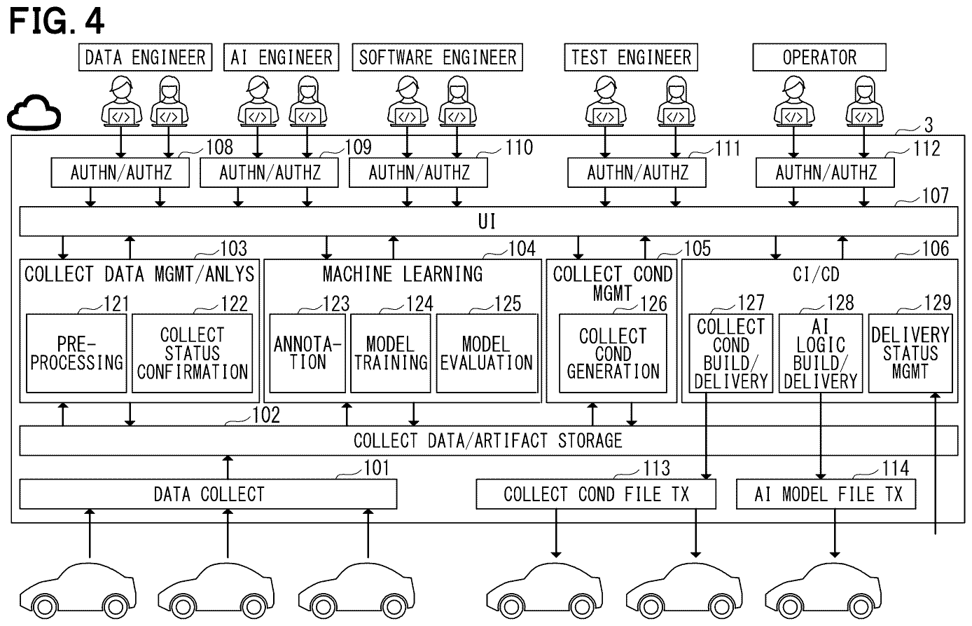

The center 3 includes, as functional blocks realized by the CPU 41 executing the program stored in the ROM 42, as shown in FIG. 4, a data collection unit 101, a collection data and product storage unit 102, a collection data management and analysis unit 103, a machine learning unit 104, a collection condition management unit 105, a CI/CD unit 106, a UI unit 107, authentication/authorization units 108, 109, 110, 111, and 112, a collection condition file transmission unit 113, and an AI model file transmission unit 114. CI is an abbreviation for Continuous Integration. CD is an abbreviation for Continuous Delivery. UI is an abbreviation for User Interface. AI is an abbreviation for Artificial Intelligence.

The data collection unit 101 collects data from a plurality of data collection devices 2 mounted on respective ones of a plurality of vehicles.

The collection data and product storage unit 102 stores data collected by the data collection unit 101 and products generated by the collection data management and analysis unit 103, the machine learning unit 104, and the collection condition management unit 105.

The collection data management and analysis unit 103 includes a preprocessing unit 121 and a collection status confirmation unit 122.

The preprocessing unit 121 performs preprocessing on the collected data in order to make it easier to use in machine learning (for example, changing resolution, converting to grayscale, and the like).

The collection status confirmation unit 122 confirms the data amount of the collected data.

The machine learning unit 104 includes an annotation unit 123, a model training unit 124, and a model evaluation unit 125.

The annotation unit 123 performs annotation for adding information for machine learning (for example, labels) to the data subjected to preprocessing by the preprocessing unit 121.

The model training unit 124 performs training of a machine learning model using the data generated by the annotation unit 123. The machine learning model is, for example, a model that receives image data captured by an in-vehicle camera as input data, determines an object in the image, and outputs a determination result.

The model evaluation unit 125 evaluates the accuracy of the machine learning model based on the training result obtained by the model training unit 124.

The collection condition management unit 105 manages collection conditions used for collecting data used for training the machine learning model. The collection condition management unit 105 includes a collection condition generation unit 126.

The collection condition generation unit 126 generates collection condition data indicating collection conditions for collecting data for improving the accuracy of the machine learning model, based on the evaluation result obtained by the model evaluation unit 125.

The CI/CD unit 106 includes a collection condition build-and-delivery unit 127, an AI logic build-and-delivery unit 128, and a delivery status management unit 129.

The collection condition build-and-delivery unit 127 converts the collection condition data generated by the collection condition generation unit 126 into a format recognizable by the data collection device 2 and delivers the converted data to the data collection device 2.

The AI logic build-and-delivery unit 128 converts a machine learning model generated by the machine learning unit 104, that is, AI logic, into a format executable by the data collection device 2 and delivers the converted AI logic to the data collection device 2.

The delivery status management unit 129 confirms the delivery status of the collection condition data and the AI logic.

The UI unit 107 is a device for exchanging information between the center 3 and a data engineer, an AI engineer, a software engineer, a test engineer, and an operator.

The data engineer is an engineer relating to data used for machine learning. The AI engineer is an engineer relating to generation of a machine learning model. The software engineer is an engineer relating to an application generated by combining a plurality of machine learning models. The test engineer is an engineer who evaluates the machine learning model and the application. The operator manages the delivery status of the collection condition data and the AI logic.

The authentication/authorization unit 108 performs authentication and authorization for access to the center 3 by the data engineer. The authentication/authorization unit 108 performs authentication and authorization, for example, so that the data engineer can access only the collection data management and analysis unit 103.

The authentication/authorization unit 109 performs authentication and authorization for access to the center 3 by the AI engineer. The authentication/authorization unit 109 performs authentication and authorization, for example, so that the AI engineer can access only the machine learning unit 104.

The authentication/authorization unit 110 performs authentication and authorization for access to the center 3 by the software engineer. The authentication/authorization unit 110 performs authentication and authorization, for example, so that the software engineer can access only the machine learning unit 104.

The authentication/authorization unit 111 performs authentication and authorization for access to the center 3 by the test engineer. The authentication/authorization unit 111 performs authentication and authorization, for example, so that the test engineer can access only the collection condition management unit 105.

The authentication/authorization unit 112 performs authentication and authorization for access to the center 3 by the operator. The authentication/authorization unit 112 performs authentication and authorization, for example, so that the operator can access only the CI/CD unit 106.

The collection condition file transmission unit 113 transmits the collection condition file generated by the collection condition build-and-delivery unit 127 to the plurality of data collection devices 2.

The AI model file transmission unit 114 transmits the AI model file generated by the AI logic build-and-delivery unit 128 to the plurality of data collection devices 2.

The authentication/authorization units 108 to 112 are configured to set different access privileges for each of a plurality of applications using the machine learning models handled by the center 3 (for example, ADAS applications and multimedia applications). ADAS is an abbreviation for Advanced Driver Assistance System.

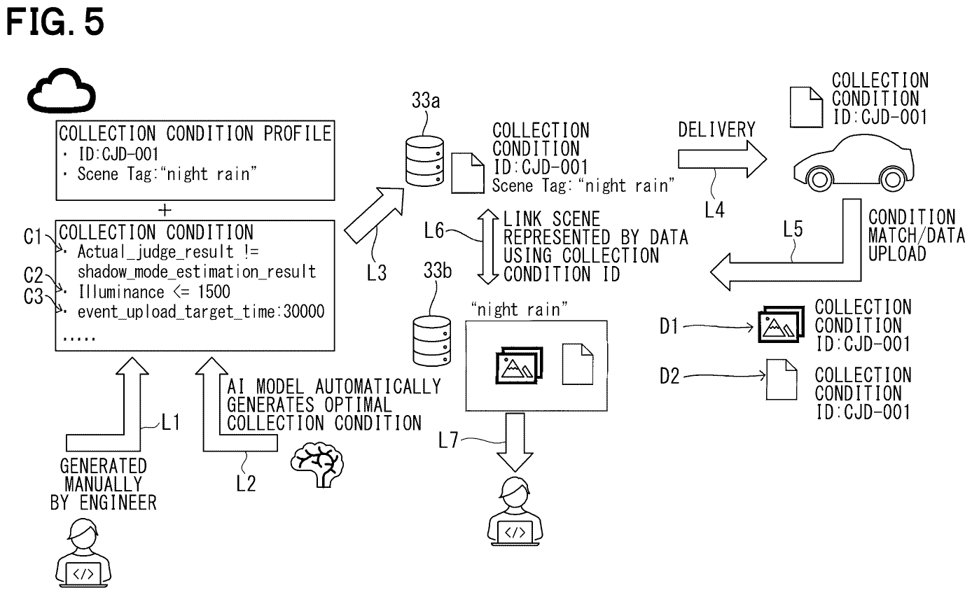

The collection condition is manually generated by an engineer or automatically generated by an AI model, as indicated by arrows L1 and L2 in FIG. 5.

The collection condition file shown in FIG. 5 includes conditions C1, C2, C3, and the like. The conditions C1 and C2 are conditions for executing data collection. Data collection is executed when both the condition C1 and the condition C2 are satisfied.

The condition C3 indicates a timing for uploading the collected data to the center 3.

A collection condition profile is appended to the collection condition file. The collection condition profile includes a collection condition ID and a scene tag. ID is an abbreviation for identification. “CJD-001” shown in FIG. 5 is a collection condition ID. “night rain” shown in FIG. 5 is a scene tag. A scene includes ambient brightness, vehicle behavior, driver operation, a traveling road, an application execution state, and the like. Therefore, the collection condition ID corresponds to the scene. The scene tag is a character string set by an engineer for identifying the scene.

The collection condition file to which the collection condition profile is appended is stored in the collection condition DB 33a, as indicated by arrow L3.

The collection condition file is delivered to the data collection device 2 mounted on the vehicle, as indicated by arrow L4.

The data collection device 2 collects at least one of image data and sensor data based on the collection condition file acquired by delivery from the center 3. Data D1 shown in FIG. 5 is image data. Data D2 shown in FIG. 5 is sensor data indicating detection results of a sensor mounted on the vehicle.

The data collection device 2 appends, to the collected data, the collection condition ID included in the collection condition profile corresponding to the collection condition file. The data collection device 2 uploads the data to which the collection condition ID has been appended to the center 3, as indicated by arrow L5.

The center 3 stores the data uploaded from the data collection device 2 in the collection data DB 33b. As indicated by arrow L6, the data stored in the collection data DB 33b is associated with a scene by the collection condition ID. Thus, the data stored in the collection data DB 33b is associated with the scene tag corresponding to the collection condition ID (for example, “night rain” in FIG. 5).

The data stored in the collection data DB 33b is used by an engineer, as indicated by arrow L7.

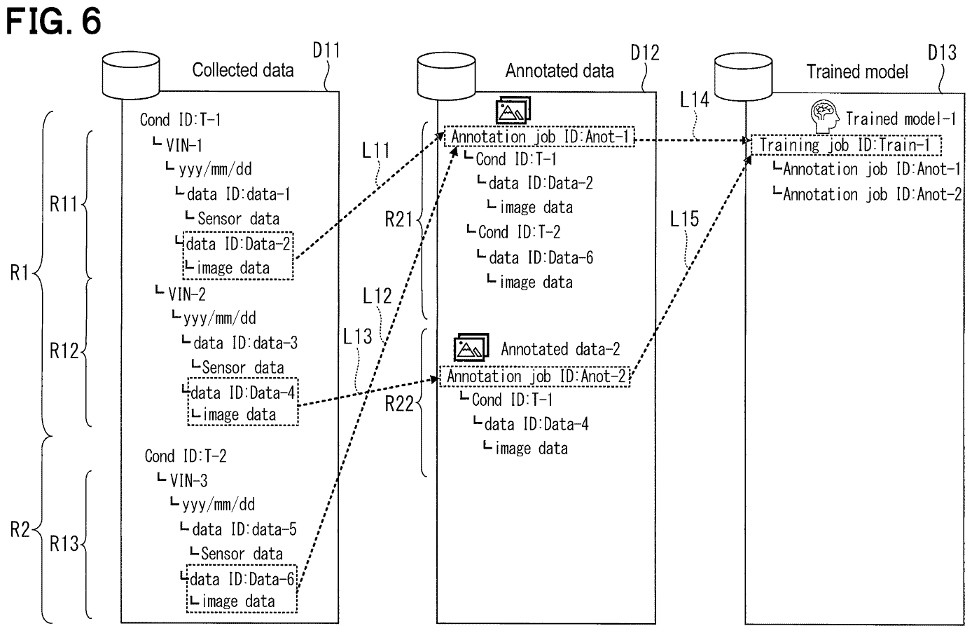

As shown in FIG. 6, the collection data metadata D11 stores data by classifying the data according to a plurality of collection conditions. The collection data metadata D11 shown in FIG. 6 includes a first collection condition storage area R1 that stores data whose collection condition ID is “T-1” and a second collection condition storage area R2 that stores data whose collection condition ID is “T-2.”

The collection data metadata D11 classifies and stores data for each of a plurality of vehicles in the collection condition storage area that stores data for each collection condition.

The first collection condition storage area R1 includes a first vehicle storage area R11 that stores data acquired from the vehicle identified by “VIN-1” and a second vehicle storage area R12 that stores data acquired from the vehicle identified by “VIN-2.”

The second collection condition storage area R2 includes a third vehicle storage area R13 that stores data acquired from the vehicle identified by “VIN-3.”

A vehicle storage area that stores data for each vehicle stores a data acquisition date and time and a data ID and data type for one or more pieces of data.

The first vehicle storage area R11 indicates, for the vehicle identified by “VIN-1,” the data acquisition date and time, that the data type of the data whose data ID is “Data-1” is sensor data, and that the data type of the data whose data ID is “Data-2” is image data.

The second vehicle storage area R12 indicates, for the vehicle identified by “VIN-2,” the data acquisition date and time, that the data type of the data whose data ID is “Data-3” is sensor data, and that the data type of the data whose data ID is “Data-4” is image data.

The third vehicle storage area R13 indicates, for the vehicle identified by “VIN-3,” the data acquisition date and time, that the data type of the data whose data ID is “Data-5” is sensor data, and that the data type of the data whose data ID is “Data-6” is image data.

The annotation job data D12 stores data by classifying the data according to a plurality of annotation jobs.

The annotation job data D12 shown in FIG. 6 includes a first annotation job storage area R21 that stores data whose annotation job ID is “Anot-1” and a second annotation job storage area R22 that stores data whose annotation job ID is “Anot-2.”

An annotation job storage area that stores data for each annotation job stores, for each collection condition ID, the collection condition ID and the data ID in association with each other.

The first annotation job storage area R21 stores in association with each other the collection condition ID “T-1” and the data ID “Data-2,” and the collection condition ID “T-2” and the data ID “Data-6.”

The second annotation job storage area R22 stores in association with each other the collection condition ID “T-1” and the data ID “Data-4.”

As indicated by arrow L11 and arrow L12, in the annotation job whose annotation job ID is “Anot-1,” image data identified by the data ID “Data-2” and collected under the collection condition identified by the collection condition ID “T-1,” and image data identified by the data ID “Data-6” and collected under the collection condition identified by the collection condition ID “T-2” are used.

As indicated by arrow L13, in the annotation job whose annotation job ID is “Anot-2,” image data identified by the data ID “Data-4” and collected under the collection condition identified by the collection condition ID “T-1” is used.

The model training job data D13 stores, in association with each other, a training job ID and one or more annotation job IDs.

The model training job data D13 shown in FIG. 6 stores, in association with each other, a model training job ID “Train-1,” an annotation job ID “Anot-1,” and an annotation job ID “Anot-2.”

As indicated by arrow L14 and arrow L15, in the model training job whose model training job ID is “Train-1,” image data generated by the annotation job identified by the annotation job ID “Anot-1” and image data generated by the annotation job identified by the annotation job ID “Anot-2” are used.

Next, a procedure of a collection data management process executed by the center 3 will be described. The collection data management process is a process repeatedly executed while the control unit 31 is operating.

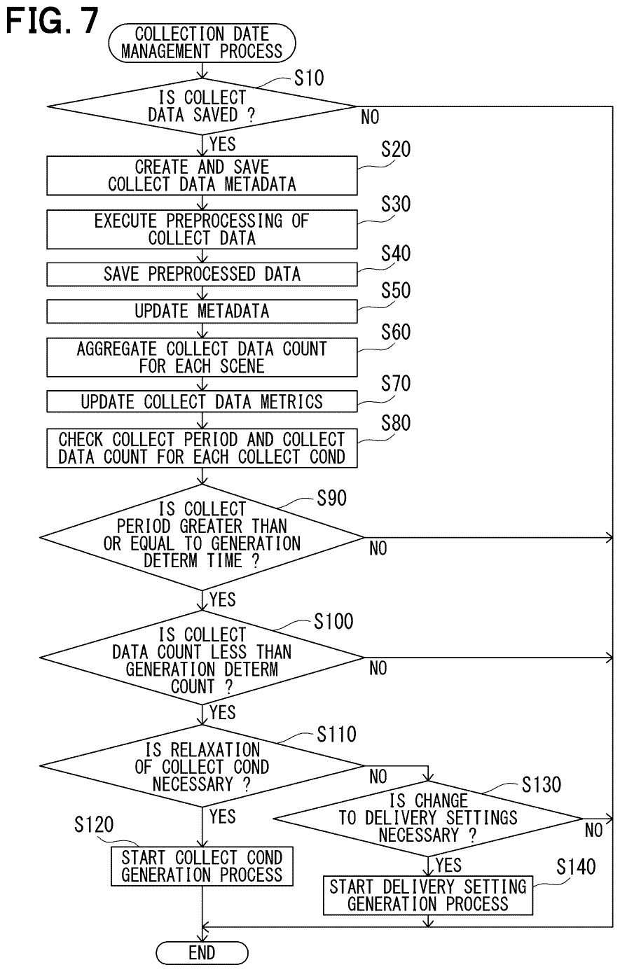

When the collection data management process is executed, the CPU 41 of the control unit 31 determines in S10 whether new collected data has been stored in the collection data DB 33b, as shown in FIG. 7. The collected data is, for example, in-vehicle camera video, in-vehicle camera still image, operation result of an application, recognition result of a sensor system, or CAN data.

Here, if new collected data has not been stored in the collection data DB 33b, the CPU 41 ends the collection data management process. On the other hand, if new collected data has been stored in the collection data DB 33b, the CPU 41 creates collection data metadata for the newly stored collected data in S20, and stores the created collection data metadata in the collection data DB 33b. The collection data metadata includes, for example, a data ID, a collection date and time, a data type (for example, CAN, application operation, moving image, still image, sensor), a collection condition ID, a vehicle ID of the collected data, and a raw data storage path.

The CPU 41 executes preprocessing of the collected data in S30. The preprocessing of the collected data includes, for example, changing resolution and converting to grayscale. As preprocessing of the collected data, processing with consideration for privacy (for example, mosaic processing) may be performed.

In S40, the CPU 41 stores the collected data subjected to preprocessing (referred to as preprocessed collected data) in the collection data DB 33b. The collection data DB 33b includes a first data storage area that stores collected data and a second data storage area that stores preprocessed collected data.

In S50, the CPU 41 updates the collection data metadata. Specifically, the CPU 41 adds, to the collection data metadata, the storage path of the preprocessed collected data stored in S40.

In S60, the CPU 41 totals the number of collected data items for each scene. Specifically, the CPU 41 counts, for each scene, the number of collected data items stored in the collection data DB 33b, based on the collection condition ID associated with the collected data.

In S70, the CPU 41 updates the collection data metrics based on the totalization result in S60. The collection data metrics include, for example, a collection condition ID, a date and time, and the number of completed collected data items. Specifically, the CPU 41 updates, for each scene, the date and time and the number of completed collected data items in the collection data metrics.

In S80, the CPU 41 confirms, for each collection condition, the time from the start of collection to the present time (referred to as the collection period) and the number of collected data items.

It should be noted that the processes of S90 to S140 described below are performed for each of a plurality of scenes.

In S90, the CPU 41 determines whether the collection period is equal to or longer than a preset generation determination time for each collection condition. Here, if the collection period is shorter than the generation determination time, the CPU 41 ends the collection data management process. On the other hand, if the collection period is equal to or longer than the generation determination time, the CPU 41 determines in S100 whether the number of collected data items is less than a preset generation determination count for each collection condition.

Here, if the number of collected data items is equal to or greater than the generation determination count, the CPU 41 ends the collection data management process. On the other hand, if the number of collected data items is less than the generation determination count, the CPU 41 determines in S110 whether relaxation of the collection condition is necessary. For example, when there is other data that can be included in the collection condition, it is determined that relaxation of the collection condition is necessary. Here, if relaxation of the collection condition is necessary, the CPU 41 starts a collection condition generation process described later in S120, and ends the collection data management process.

On the other hand, if relaxation of the collection condition is unnecessary, the CPU 41 determines in S130 whether a change in the delivery setting is necessary. For example, when the vehicle model to be delivered to or the region to be delivered to can be changed, it is determined that a change in the delivery setting is necessary. Here, if a change in the delivery setting is unnecessary, the CPU 41 ends the collection data management process. On the other hand, if a change in the delivery setting is necessary, the CPU 41 starts a delivery setting generation process in S140 and ends the collection data management process. In the delivery setting generation process, the CPU 41 expands the delivery target region or increases the number of delivery target vehicle models.

Next, a procedure of a model training process executed by the center 3 will be described. The model training process is started when the collected data used for training the machine learning model is updated, or when a preset execution cycle has elapsed.

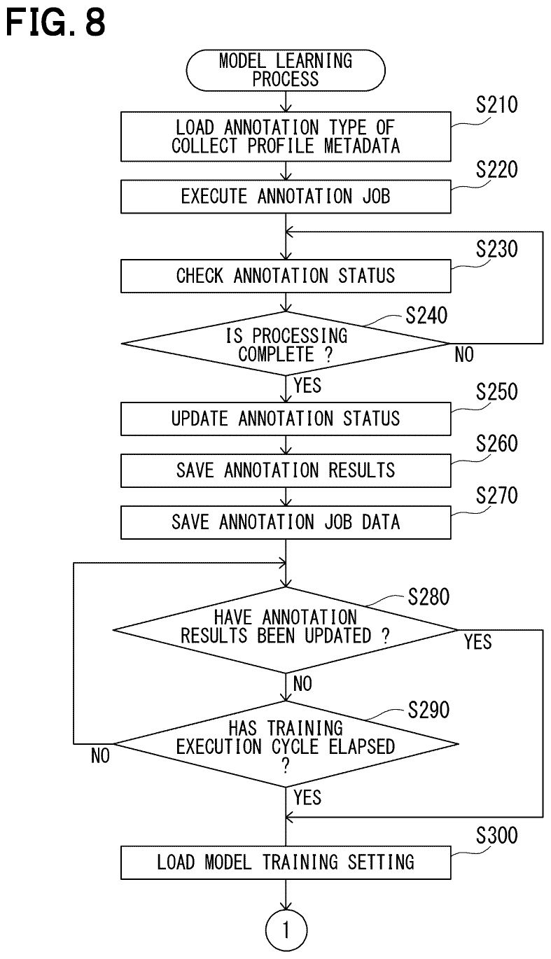

When the model training process is executed, the CPU 41 of the control unit 31 reads the annotation type included in the collection profile metadata of the collected data used for training the machine learning model in S210, as shown in FIG. 8. The collection profile metadata includes a collection condition ID, a creation date and time, a collection start date and time, a scene tag, an annotation type, and a collection condition status.

The scene tag includes, for example, “rainy” and “night,” and can be set in combination. The annotation type indicates the type of annotation. The collection condition status indicates whether delivery to the vehicle has been completed.

In S220, the CPU 41 executes an annotation job based on the annotation type read in S210. By executing the annotation job, annotation results and annotation job data are generated. The annotation job data includes an annotation job ID, a start date and time, a pair of a data ID and a collection condition ID, a status (for example, job in progress, success, failure), and a result storage path.

In S230, the CPU 41 checks the status included in the annotation job data (referred to as the annotation status).

In S240, the CPU 41 determines, based on the check result in S230, whether the annotation job has been completed. Here, if the annotation job has not been completed, the CPU 41 proceeds to S230. On the other hand, if the annotation job has been completed, the CPU 41 updates, in S250, the annotation status included in the annotation job data.

In S260, the CPU 41 stores the annotation results in the storage unit 33.

In S270, the CPU 41 stores the annotation job data in the storage unit 33.

In S280, the CPU 41 determines whether the annotation results have been updated. Here, if the annotation results have been updated, the CPU 41 proceeds to S300. On the other hand, if the annotation results have not been updated, the CPU 41 determines in S290 whether a preset training execution cycle has elapsed.

Here, if the training execution cycle has not elapsed, the CPU 41 returns to S280. On the other hand, if the training execution cycle has elapsed, the CPU 41 proceeds to S300.

When the process proceeds to S300, the CPU 41 reads the model training setting. The model training setting includes a training setting ID, a pair consisting of a required data type and a data count, and a path to a server setting file. The pair of the required data type and the data count is information indicating the number of new data items required to start model training. The path of the server setting file is information indicating a computing environment used in model training.

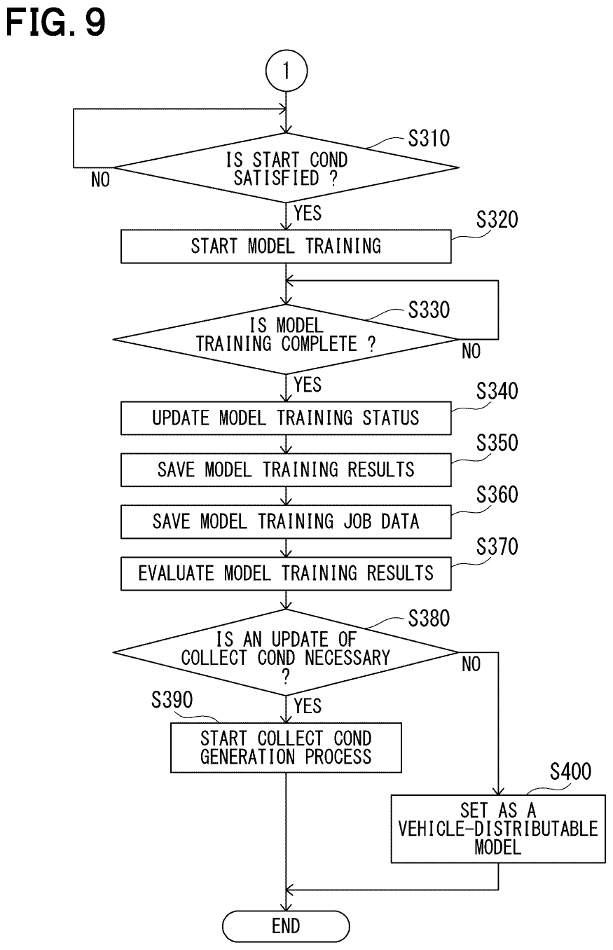

As shown in FIG. 9, in S310, the CPU 41 determines whether a start condition indicated by the read model training setting is satisfied. The start condition indicated by the model training setting is defined by the pair of the required data type and the data count.

Here, if the start condition is not satisfied, the CPU 41 waits until the start condition is satisfied by repeating the process of S310. Then, when the start condition is satisfied, the CPU 41 starts model training in S320. By executing the model training, a model training result and model training job data are generated. The model training job data includes a training job ID, a start date and time, a list of annotation job IDs, a status (for example, job in progress, success, failure), and a training result storage path.

In S330, the CPU 41 determines whether the model training has been completed. Here, if the model training has not been completed, the CPU 41 waits until the model training is completed by repeating the process of S330. Then, when the model training is completed, the CPU 41 updates the status of the model training job data in S340.

In S350, the CPU 41 stores the model training result in the storage unit 33.

In S360, the CPU 41 stores the model training job data in the storage unit 33.

In S370, the CPU 41 evaluates the model training result. The evaluation of the model training result includes evaluating whether the machine learning model is operating properly using, as evaluation data, a scene in which the machine learning model was not operating properly, and detecting weak points of the machine learning model by checking whether the machine learning model is operating properly by adding noise to the annotation results or extracting a part of an image.

In S380, the CPU 41 determines, based on the evaluation result in S370, whether updating of the collection condition is necessary. For example, when the CPU 41 identifies a scene in which the machine learning model does not satisfy a preset evaluation criterion, the CPU 41 determines that updating of the collection condition is necessary.

Here, if updating of the collection condition is necessary, the CPU 41 starts a collection condition generation process described later in S390, and ends the model training process. On the other hand, if updating of the collection condition is unnecessary, the CPU 41 sets, in S400, the machine learning model obtained by the model training as a vehicle-distributable model, and ends the model training process.

Next, a procedure of a collection condition generation process executed by the center 3 will be described. The collection condition generation process is started by the process of S120 or S390.

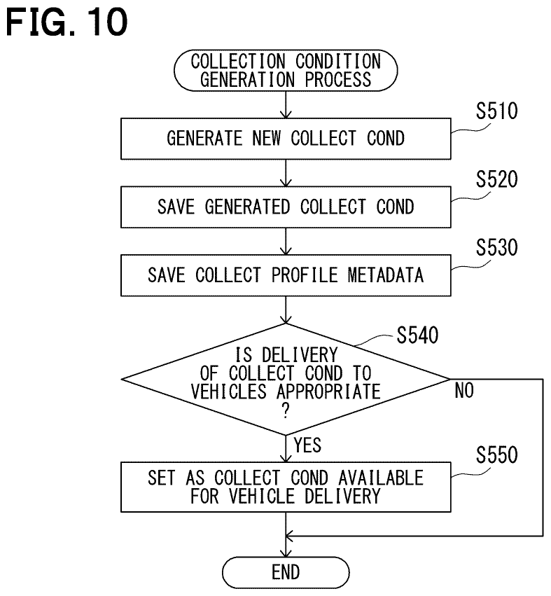

When the collection condition generation process is executed, the CPU 41 of the control unit 31 generates a new data collection condition in S510, as shown in FIG. 10. Specifically, when the CPU 41 identifies a scene in which the machine learning model does not satisfy a preset evaluation criterion, the CPU 41 generates a collection condition for collecting data related to the identified scene. In addition, when the CPU 41 detects a weak point of the machine learning model, the CPU 41 generates a collection condition for collecting data for overcoming the weak point of the machine learning model. Further, when relaxation of the collection condition is necessary, the CPU 41 generates a data collection condition by relaxing the restrictions through changing threshold values such as the collection start period and the number of collected data items.

In S520, the CPU 41 stores, in the collection condition DB 33a, a collection condition file indicating the collection condition generated in S510. As described above, the collection condition profile is added to the collection condition file.

In S530, the CPU 41 stores, in the collection condition DB 33a, the collection profile metadata of the collection condition generated in S510.

In S540, the CPU 41 determines whether the collection condition generated in S510 is appropriate for delivery to the vehicle. Here, if the collection condition is not appropriate for delivery to the vehicle, the CPU 41 ends the collection condition generation process. On the other hand, if the collection condition is appropriate for delivery to the vehicle, the CPU 41 sets, in S550, the collection condition generated in S510 as a collection condition that can be distributed to the vehicles, and ends the collection condition generation process.

Next, a procedure of a delivery process executed by the center 3 will be described. The delivery process is started when the operator performs an input operation via the UI unit 107 for starting the delivery process.

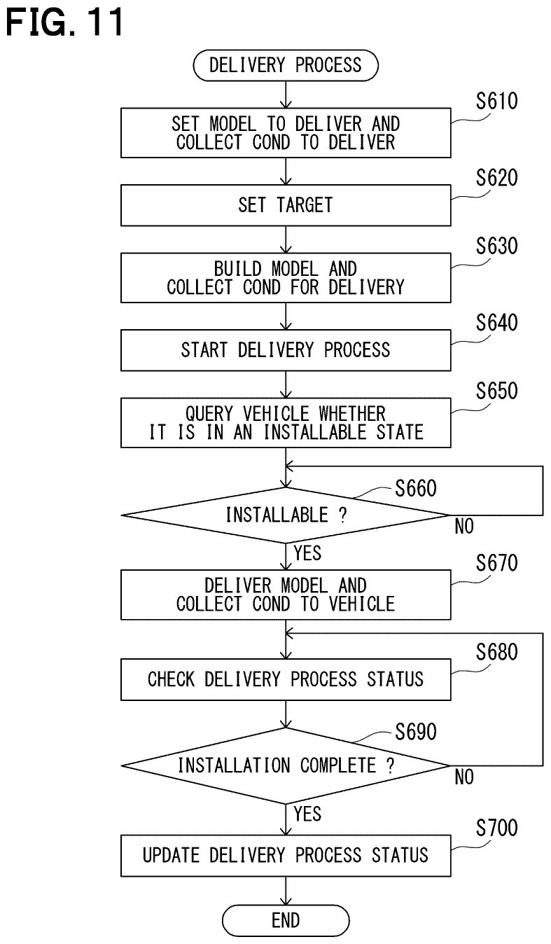

When the delivery process is executed, the CPU 41 of the control unit 31 sets, in S610, a machine learning model and a collection condition to be delivered, from among machine learning models and collection conditions that can be distributed to the vehicles, based on the input operation performed by the operator via the UI unit 107, as shown in FIG. 11.

In S620, the CPU 41 sets vehicles to be subjected to delivery (that is, targets) by using data for each individual vehicle, such as the vehicle type, the target region, and the frequency of use of functions.

In S630, the CPU 41 builds the machine learning model and the collection condition set in S610 for delivery.

In S640, the CPU 41 starts a process of delivering, to the target set in S620, the machine learning model and the collection condition built in S630.

It should be noted that the processes of S650 to S700 described below are performed for each of the plurality of targets.

In S650, the CPU 41 inquires of the vehicle whether the vehicle is in an installable state. Examples of a state in which installation is not possible include a state in which storage is insufficient because the vehicle is traveling and executing another higher-priority application, or a state in which Wi-Fi communication is not possible. Wi-Fi is a registered trademark.

In S660, the CPU 41 determines whether the vehicle to be subjected to delivery is in an installable state. Here, if the vehicle is not in an installable state, the CPU 41 waits until the vehicle becomes installable by repeating the process of S660.

Then, when the vehicle becomes in an installable state, the CPU 41 delivers, in S670, the machine learning model and the collection condition set in S610 to the vehicle to be subjected to delivery.

In S680, the CPU 41 confirms the delivery process status.

In S690, the CPU 41 determines, based on the confirmation result in S680, whether installation has been completed. Here, if installation has not been completed, the CPU 41 proceeds to S680. On the other hand, if installation has been completed, the CPU 41 updates the delivery process status in S700 and ends the delivery process.

Next, a procedure of a data collection process executed by the control unit 11 of the data collection device 2 will be described. The data collection process is a process repeatedly executed while the control unit 11 is operating.

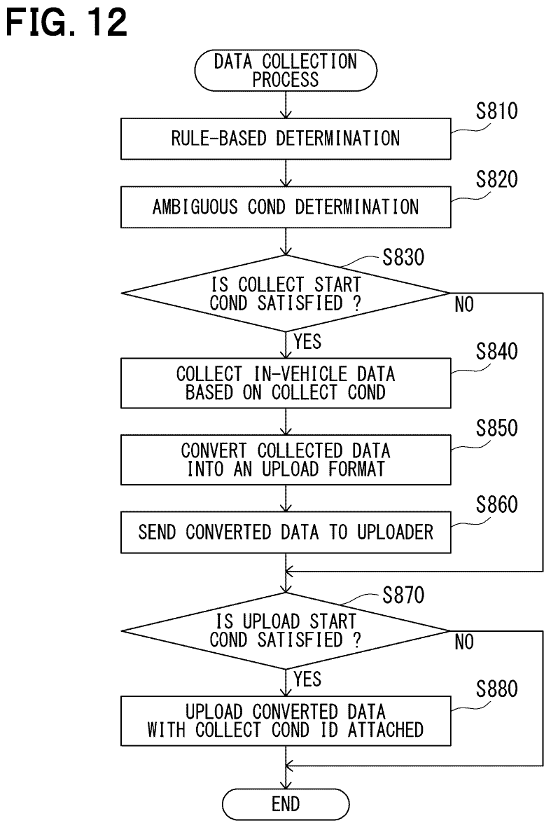

When the data collection process is executed, the CPU 21 of the control unit 11 performs a rule-based determination in S810, as shown in FIG. 12. In the rule-based determination, the CPU 21 makes a determination based on numerical values, for example, whether a detected value by a sensor is equal to or greater than a threshold value.

In S820, the CPU 21 performs a determination of ambiguous conditions. In the determination of ambiguous conditions, the CPU 21 determines, by an AI application, a condition that is difficult to express numerically, such as “heavy rain” or “light rain,” using an image captured by the in-vehicle camera.

In S830, the CPU 21 determines, based on the determination results in S810 and S820, whether a collection start condition included in the collection condition has been satisfied. The collection condition includes a collection data item indicating the type of data to be collected, the collection start condition for starting data collection, conditions for data sampling, conditions for trimming video data, an upload start condition indicating the timing for uploading data, and the like.

The type of data to be collected is, for example, in-vehicle data, such as camera data, sensor data, CAN data, and AI logic operation logs.

The condition for starting data collection is set, for example, by a driver's override operation, a rule-based condition based on a value of CAN data, an operation result of an application, a specific scene, or a combination of these conditions.

The driver override refers, for example, to a driver stepping on a brake pedal during automated driving, a driver performing a steering operation during automated driving, switching from automatic wiper control to manual control, canceling shuffle playback of music, canceling use of a voice recognition function during use, canceling a proposal from an in-vehicle agent, or the like, that is, a manual intervention into a function that is automatically controlled by the vehicle system.

The rule-based condition based on the value of CAN data is, for example, that the illuminance becomes equal to or lower than a predetermined value, that the acceleration becomes equal to or higher than a predetermined value, or the like. The specific scene is, for example, daytime, nighttime, rain, fog, snow, and the like.

Here, if the collection condition has not been satisfied, the CPU 21 proceeds to S870. On the other hand, if the collection condition has been satisfied, the CPU 21 collects the in-vehicle data based on the collection condition in S840.

In S850, the CPU 21 converts the collected data into an upload format.

In S860, the CPU 21 transmits the data converted into the upload format to an uploader, and proceeds to S870.

When the process proceeds to S870, the CPU 21 determines whether the upload start condition included in the collection condition has been satisfied. Here, if the upload start condition has not been satisfied, the CPU 21 ends the data collection process. On the other hand, if the upload start condition has been satisfied, the CPU 21 uploads, in S880, the collected data corresponding to the collection condition to the center 3 by the uploader, with a collection condition ID corresponding to the collection condition added thereto, and ends the data collection process. Note that the collected data uploaded to the center 3 is the data converted into the upload format in S850.

The data collection system 1 configured as described above includes a plurality of data collection devices 2 and a center 3.

The plurality of data collection devices 2 are mounted in respective ones of a plurality of vehicles and are configured to transmit vehicle data including at least information concerning the vehicle on which they are mounted. The center 3 is configured to receive the vehicle data from the plurality of data collection devices 2.

The center 3 stores vehicle data received from the plurality of data collection devices 2.

Using the stored vehicle data, the center 3 identifies, based on a result of model evaluation obtained by performing machine learning including annotation, model training, and model evaluation with respect to a machine learning model, a scene in which the machine learning model does not satisfy a preset evaluation criterion, generates, for the identified scene, collection condition data indicating a collection condition including a collection data item indicating a type of vehicle data to be collected and a collection start condition for starting data collection, and stores the generated collection condition data in association with a scene tag for identifying the scene.

The center 3 distributes the collection condition data to the plurality of data collection devices 2.

The center 3 stores vehicle data uploaded from the plurality of data collection devices 2 based on the collection condition data in association with the scene tag.

Such a center 3 can efficiently collect data from the plurality of data collection devices 2 because it can collect vehicle data by narrowing down the data according to scenes. Furthermore, because the center 3 identifies scenes that do not satisfy the evaluation criterion and generates the collection condition data, it can efficiently generate the collection condition data.

The center 3 generates traceability information for enabling a process of generating collection condition data or a process of collecting vehicle data to be traced.

The traceability information includes a collection condition profile capable of associating the generated collection condition data with a scene, and collection data metadata D11 capable of associating the vehicle data with a scene. This enables the center 3 to trace the process of generating the collection condition data or the process of collecting the vehicle data.

The traceability information includes annotation job data D12 and model training job data D13 capable of associating a machine learning model with vehicle data used in machine learning for the machine learning model. This enables the center 3 to trace the process of generating the collection condition data or the process of collecting the vehicle data.

The center 3 sets access privileges to the center 3 for each of a plurality of functions constituting the center 3, that is, the collection data management and analysis unit 103, the machine learning unit 104, the collection condition management unit 105, and the CI/CD unit 106. This enables the center 3 to improve security for the data stored by the center 3.

The center 3 sets access privileges to the center 3 for each of a plurality of applications using the machine learning model. This enables the center 3 to further improve security for the data stored by the center 3.

In the embodiment described above, the data collection device 2 corresponds to the in-vehicle device, S40 and S50 correspond to processing as the data storage unit, S510 and S520 correspond to processing as the collection condition generation unit, and S670 corresponds to processing as the delivery unit.

Further, S840 corresponds to processing as the collection unit, and S880 corresponds to processing as the upload unit, and the scene tag corresponds to the scene identification information.

### Second Embodiment

The second embodiment of the present disclosure will be described below with reference to the drawings. In the second embodiment, differences from the first embodiment will be described. Components common to both embodiments are denoted by the same reference numerals.

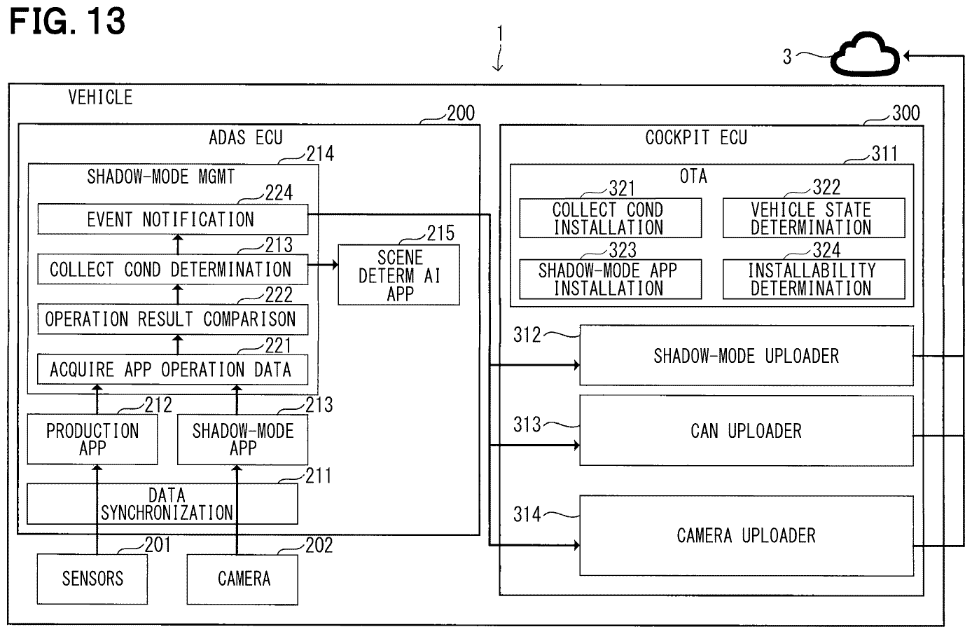

As shown in FIG. 13, the data collection system 1 according to the second embodiment differs from that of the first embodiment in that it includes an ADAS ECU 200 and a cockpit ECU 300 instead of the data collection device 2.

The ADAS ECU 200 includes a data synchronization unit 211, a production application 212, a shadow-mode application 213, a shadow-mode management unit 214, and a scene-determination AI application 215. The production application may be referred to as a mass-production application.

The data synchronization unit 211 synchronizes detection data detected by sensors 201 mounted on the vehicle and image data captured by a camera 202 mounted on the vehicle, outputs the detection data from the sensors 201 to the production application 212, and outputs the image data captured by the camera 202 to the shadow-mode application 213.

The production application 212 is an application actually applied to the vehicle.

The shadow-mode application 213 is an application that performs a predetermined calculation based on input data, but does not actually apply the calculation result to the vehicle.

The shadow-mode management unit 214 includes an application operation data acquisition unit 221, an operation result comparison unit 222, a collection condition determination unit 223, and an event notification unit 224.

The application operation data acquisition unit 221 acquires data indicating the operation of the production application 212 and data indicating the operation of the shadow-mode application 213.

The operation result comparison unit 222 compares the operation of the production application 212 with the operation of the shadow-mode application 213.

The collection condition determination unit 223 determines whether a collection condition is satisfied, based on the operation comparison result from the operation result comparison unit 222 and the determination result of the scene-determination AI application 215. The collection condition is that the operation comparison result from the operation result comparison unit 222 does not match. The scene-determination AI application 215 determines a scene by AI logic when the scene included in the collection condition is ambiguously specified. The ambiguously specified scene is, for example, backlighting or evening.

When the collection condition determination unit 223 determines that the collection condition is satisfied, the event notification unit 224 transmits data collected based on the collection condition to the cockpit ECU 300.

The cockpit ECU 300 includes an OTA unit 311, a shadow-mode uploader 312, a CAN uploader 313, and a camera uploader 314. OTA is an abbreviation for Over the Air.

The OTA unit 311 includes a collection condition installation unit 321, a vehicle state determination unit 322, a shadow-mode application installation unit 323, and an installability determination unit 324.

The collection condition installation unit 321 installs the collection condition data distributed from the center 3 into the ADAS ECU 200.

The vehicle state determination unit 322 determines the state of the vehicle on which the cockpit ECU 300 is mounted (for example, shift position and power supply state).

The shadow-mode application installation unit 323 installs the shadow-mode application distributed from the center 3 into the ADAS ECU 200.

The installability determination unit 324 determines whether the vehicle on which the cockpit ECU 300 is mounted is in a state in which the collection condition data or the shadow-mode application can be installed.

When a preset shadow-mode upload condition is satisfied, the shadow-mode uploader 312 uploads to the center 3 the operation comparison result received from the ADAS ECU 200.

When a preset CAN upload condition is satisfied, the CAN uploader 313 uploads to the center 3 the CAN data received from the ADAS ECU 200.

When a preset camera upload condition is satisfied, the camera uploader 314 uploads to the center 3 the camera data received from the ADAS ECU 200.

Using various data uploaded to the center 3, an application is developed that replaces the sensors 201 with the camera 202 and performs control equivalent to or better than conventional control.

In the data collection system 1 configured as described above, the collection start condition includes identification information indicating a scene (in the present embodiment, for example, “backlighting” and “evening”), and the ADAS ECU 200 is equipped with a scene-determination AI application 215 that determines, using data handled in the vehicle, a scene specified by the above identification information. As a result, the data collection system 1 can include, in the collection condition, an ambiguous expression indicating a scene. Note that the above identification information may be a name of a scene, an ID indicating a scene, or a tag indicating a scene.

In the embodiment described above, the ADAS ECU 200 and the cockpit ECU 300 correspond to the in-vehicle device, and the data synchronization unit 211, the production application 212, the shadow-mode application 213, the shadow-mode management unit 214, and the scene-determination AI application 215 correspond to the collection unit.

Further, the shadow-mode uploader 312, the CAN uploader 313, and the camera uploader 314 correspond to an upload unit, the production application 212 corresponds to a vehicle-applied application, and the scene-determination AI application 215 corresponds to a condition determination application.

Although embodiments of the present disclosure has been described above, the present disclosure is not limited to the above embodiment and can be implemented with various modifications.

### Modification Example 1

In the above embodiment, a mode was described in which collected data is uploaded to the center 3 when the upload condition is satisfied. However, the center 3 may be configured to acquire, from the data collection device 2 or the cockpit ECU 300, vehicle data stored in the data collection device 2 or the cockpit ECU 300 when a preset acquisition condition is satisfied. This makes it possible for the center 3 to acquire vehicle data at a desired timing.

### Modification Example 2

In the above embodiment, a mode was described in which vehicle data is collected when the result of comparison between the operation of the production application 212 and the operation of the shadow-mode application 213 does not match. However, in the ADAS ECU 200, when the driver of the vehicle performs an override operation, the vehicle driving operation data by the driver, the data handled by the production application 212, and the data handled by the shadow-mode application 213 may be collected.

### Modification Example 3

In the above embodiment, a mode was described in which vehicles to which data is to be distributed are set using, for example, data for each individual vehicle such as the target vehicle type, target region, and frequency of use of functions. However, the collection condition data may be distributed by selecting, based on a scene identified as not satisfying an evaluation criterion by machine learning model evaluation or based on the content of the collection condition, a region to which the collection condition data is to be distributed, attributes of a vehicle user, and a vehicle type. Examples of the attributes of the vehicle user include age. As a result, since the center 3 identifies scenes that do not satisfy the evaluation criterion and distributes the collection condition data, vehicle data can be efficiently collected.

### Modification Example 4

In the above embodiment, a mode was described in which a collection condition for collecting scenes that do not satisfy an evaluation criterion is generated, or a collection condition for collecting data to overcome weaknesses of a machine learning model is generated. However, in order to collect data that is insufficient for training the machine learning model, the number of target vehicles may be increased, scenes to be collected may be added, the collection condition may be modified, or the collection data item may be modified. As a result, since the center 3 identifies insufficient data and generates the collection condition data, vehicle data can be efficiently collected.

### Modification Example 5

In the above embodiment, a mode was described in which one collection condition corresponds to one scene. However, a plurality of collection conditions may correspond to one scene.

For example, a first scene having a scene ID of “0100” may correspond to a first collection condition having a collection condition ID of “0100001” and a second collection condition having a collection condition ID of “0100010,” and a second scene having a scene ID of “0111” may correspond to a third collection condition having a collection condition ID of “01110001.” The scene ID corresponds to the scene identification information.

The control units 11 and 31 described in the present disclosure and the methods thereof may be implemented by dedicated computers provided by configuring a processor and memory programmed to execute one or more functions embodied by a computer program. Alternatively, the control units 11 and 31 described in the present disclosure and the methods thereof may be implemented by dedicated computers provided by configuring a processor with one or more dedicated hardware logic circuits. Or, the control units 11 and 31 described in the present disclosure and the methods thereof may be implemented by one or more dedicated computers configured by a combination of a processor and memory programmed to execute one or more functions and a processor configured by one or more hardware logic circuits. Further, the computer program may be stored in a non-transitory computer-readable recording medium as instructions to be executed by a computer. The method for realizing the functions of the respective units included in the control units 11 and 31 does not necessarily need to include software, and all of the functions may be realized using one or more pieces of hardware.

A plurality of functions possessed by one constituent element in the above embodiment may be realized by a plurality of constituent elements, or one function possessed by one constituent element may be realized by a plurality of constituent elements. Further, a plurality of functions possessed by a plurality of constituent elements may be realized by one constituent element, or one function realized by a plurality of constituent elements may be realized by one constituent element. Further, some of the configurations of the above embodiment may be omitted. Further, at least a part of the configurations of the above embodiment may be added to or replaced with the configurations of another of the above embodiments.

In addition to the data collection device 2 and the center 3 described above, the present disclosure may also be realized in various forms, such as a system including the data collection device 2 and the center 3 as constituent elements, a program for causing a computer to function as the data collection device 2 and the center 3, a non-transitory computer-readable recording medium such as a semiconductor memory in which this program is recorded, and a data collection method.

What is claimed is:

1. A data collection method executed in a center configured to receive vehicle data from a plurality of in-vehicle devices mounted in each of a plurality of vehicles, the vehicle data including at least information relating to a vehicle on which the in-vehicle device is mounted, the data collection method comprising:
storing the vehicle data received from the plurality of in-vehicle devices;
identifying, based on a result of model evaluation obtained by performing machine learning including annotation, model training, and model evaluation on a machine learning model using the stored vehicle data, a scene in which the machine learning model does not satisfy a preset evaluation criterion;
generating, for the identified scene, collection condition data indicating a collection condition including a collection data item indicating a type of the vehicle data to be collected and a collection start condition for starting data collection;
storing the generated collection condition data in association with scene identification information for identifying the scene;
delivering the collection condition data to the plurality of in-vehicle devices; and
storing, in association with the scene identification information, the vehicle data uploaded from the plurality of in-vehicle devices based on the collection condition data.

2. The data collection method according to claim 1, further comprising
generating traceability information for enabling traceability of the process of generating the collection condition data or the process of collecting the vehicle data.

3. The data collection method according to claim 2, wherein
the traceability information includes (i) information capable of associating the generated collection condition data with the scene and (ii) information capable of associating the vehicle data with the scene.

4. The data collection method according to claim 2, wherein
the traceability information includes information capable of associating the machine learning model with the vehicle data used in the machine learning performed on the machine learning model.

5. The data collection method according to claim 1, further comprising
setting access privilege to the center for each of a plurality of functions constituting the center.

6. The data collection method according to claim 1, further comprising
setting access privilege to the center for each of a plurality of applications that use the machine learning model.

7. The data collection method according to claim 1, wherein
based on the result of the model evaluation or the content of the collection condition, a region, an attribute of a vehicle user, and a vehicle type are selected as targets to which the collection condition data is to be delivered, and
the collection condition data is then delivered.

8. The data collection method according to claim 1, wherein, based on a result of the model evaluation, the data collection method further comprises at least one of increasing the number of target vehicles, adding a scene to be collected, modifying the collection condition, or modifying the collection data item, in order to collect data that is lacking for the machine learning performed on the machine learning model.

9. The data collection method according to claim 1, wherein
the collection start condition includes identification information indicating the scene, and
each of the plurality of in-vehicle devices is equipped with a condition determination application configured to determine the scene specified by the identification information using data handled in the vehicle.

10. The data collection method according to claim 1, wherein
the collection start condition includes that a driver of the vehicle performs an override operation, and
the collection data item includes:
vehicle driving operation data by the driver;
data handled by a vehicle-applied application mounted on the vehicle and configured to apply, to the vehicle, control related to the override operation; and
data handled by a shadow-mode application mounted on the vehicle and operating in shadow mode.

11. A center configured to receive vehicle data from a plurality of in-vehicle devices mounted in each of a plurality of vehicles, the vehicle data including at least information relating to a vehicle on which the in-vehicle device is mounted, the center comprising:
a data storage unit configured to store the vehicle data received from the plurality of in-vehicle devices;
a collection condition generation unit configured to:
identify, based on a result of model evaluation obtained by performing machine learning including annotation, model training, and model evaluation on a machine learning model using the stored vehicle data, a scene in which the machine learning model does not satisfy a preset evaluation criterion;
generate, for the identified scene, collection condition data indicating a collection condition including a collection data item indicating a type of the vehicle data to be collected and a collection start condition for starting data collection; and
store the generated collection condition data in association with scene identification information for identifying the scene; and
a delivery unit configured to deliver the collection condition data to the plurality of in-vehicle devices,
wherein
the data storage unit is configured to store, in association with the scene identification information, the vehicle data uploaded from the plurality of in-vehicle devices based on the collection condition data.

12. A non-transitory computer-readable storage medium storing a data collection program that causes a computer of a center configured to receive vehicle data from a plurality of in-vehicle devices mounted in each of a plurality of vehicles, the vehicle data including at least information relating to a vehicle on which the in-vehicle device is mounted, to function as:
a data storage unit configured to store the vehicle data received from the plurality of in-vehicle devices;
a collection condition generation unit configured to:
identify, based on a result of model evaluation obtained by performing machine learning including annotation, model training, and model evaluation on a machine learning model using the stored vehicle data, a scene in which the machine learning model does not satisfy a preset evaluation criterion;
generate, for the identified scene, collection condition data indicating a collection condition including a collection data item indicating a type of the vehicle data to be collected and a collection start condition for starting data collection; and
store the generated collection condition data in association with scene identification information for identifying the scene; and
a delivery unit configured to deliver the collection condition data to the plurality of in-vehicle devices,
wherein
the data storage unit is configured to store, in association with the scene identification information, the vehicle data uploaded from the plurality of in-vehicle devices based on the collection condition data.

13. A data collection system comprising:
a plurality of in-vehicle devices mounted in respective ones of a plurality of vehicles and configured to transmit vehicle data including at least information relating to the vehicle on which the in-vehicle device is mounted; and
a center configured to receive the vehicle data from the plurality of in-vehicle devices,
wherein the center includes:
a data storage unit configured to store the vehicle data received from the plurality of in-vehicle devices;
a collection condition generation unit configured to:
identify, based on a result of model evaluation obtained by performing machine learning including annotation, model training, and model evaluation on a machine learning model using the stored vehicle data, a scene in which the machine learning model does not satisfy a preset evaluation criterion;
generate, for the identified scene, collection condition data indicating a collection condition including a collection data item indicating a type of the vehicle data to be collected and a collection start condition for starting data collection; and
store the generated collection condition data in association with scene identification information for identifying the scene, and
a delivery unit configured to deliver the collection condition data to the plurality of in-vehicle devices; and
wherein the data storage unit is configured to store, in association with the scene identification information, the vehicle data uploaded from the plurality of in-vehicle devices based on the collection condition data, and
wherein the plurality of in-vehicle devices include:
a collection unit configured to, upon receiving the collection condition data from the center, collect the vehicle data corresponding to the collection data item at a timing at which the collection start condition is satisfied, based on the collection condition indicated by the collection condition data; and
an upload unit configured to upload the vehicle data collected based on the collection condition to the center in association with the collection condition.

14. A data collection method executed in a data collection system including a plurality of in-vehicle devices mounted in respective ones of a plurality of vehicles and configured to transmit vehicle data including at least information relating to the vehicle on which the in-vehicle device is mounted, and a center configured to receive the vehicle data from the plurality of in-vehicle devices, the data collection method comprising:
by the center,
storing the vehicle data received from the plurality of in-vehicle devices;
identifying, based on a result of model evaluation obtained by performing machine learning including annotation, model training, and model evaluation on a machine learning model using the stored vehicle data, a scene in which the machine learning model does not satisfy a preset evaluation criterion;
generating, for the identified scene, collection condition data indicating a collection condition including a collection data item indicating a type of the vehicle data to be collected and a collection start condition for starting data collection; and
storing the generated collection condition data in association with scene identification information for identifying the scene;
delivering the collection condition data to the plurality of in-vehicle devices; and
storing the vehicle data uploaded from the plurality of in-vehicle devices based on the collection condition data in association with the scene identification information; and
by the plurality of in-vehicle devices,
collecting, upon receiving the collection condition data from the center, the vehicle data corresponding to the collection data item at a timing at which the collection start condition is satisfied, based on the collection condition indicated by the collection condition data; and
uploading the vehicle data collected based on the collection condition to the center in association with the collection condition.
